(19) United States
(12) Patent Application Publication
(10) Pub. No.: US 2012/0260471 A1
(43) Pub. Date: Oct. 18, 2012

(54) Clamp for an Elongated Lamp

(75) Inventor: Chris Conti, North Bergen, NJ (US)

(73) Assignee: PRODUCTION RESOURCE GROUP L.L.C, New Windsor, NY (US)

(21) Appl. No.: 13/523,225

(22) Filed: Jun. 14, 2012

Related U.S. Application Data
(63) Continuation of application No. 12/022,816, filed on Jan. 30, 2008.
(60) Provisional application No. 60/888,510, filed on Feb. 6, 2007.

(51) Int. Cl. F21V 21/00

(52) U.S. Cl. 24/458

(57) ABSTRACT

A clamp for an elongated tube style white such as a versa tube. The clamp has one fixed side that holds the versa tube's mounting structure therein. The other side of the clamp is movable, and pivots between an open position and a closed position. In the closed position, the lamp is held into place, and in the open position the lamp can be removed. A single screw that holds the clamp into the open or closed position is knurled and hence the device can be removed without any tools. The two sides of the clamp occupy different longitudinal positions so that they can be placed directly next to each other, and one opened without moving or disturbing the other since the two sides are in different longitudinal positions.

This application claims priority to provisional application Ser. No. 60/888,510 filed Feb. 6, 2007, the disclosure of which is herewith incorporated by reference.

### BACKGROUND

The versa tube lamp is an elongated lamp with a base connection and a top portion. For example, FIG. 1A shows a side view of a versa tube. The base 100 houses lighting elements, for example plural spaced LEDs. The top portion 105 includes a dome that allows viewing the lit LEDs.

The bottom portion of the versa tube lamp includes protruding notches shown respectively as 110, 111 that can be used for mounting the base. The mounting structure, shown in FIG. 1B, includes corresponding notches. Notch 150 holds a corresponding notch 110 on the versa tube 110. The other versa tube notch 111 similarly fits into a notch 151 that is formed on the other side of the clamp. The versa tube can be slid into place, or can be placed in place and then screwed in with a screw portion 155.

The clamp requires tools to assemble. Also, it may be difficult to remove lights when the clamps are placed one right against the other with the long axes parallel to one another.

### BRIEF DESCRIPTION OF THE DRAWINGS

In the figures:

FIG. 1A shows a side view of the tube;

FIG. 1B shows the mounting structure of the tube;

FIG. 2 shows an end view of the tube and the clamping device;

FIG. 3 shows a detailed view of the clamp;

FIG. 4 shows a top view of the clamp;

FIG. 5 shows two versa tube clamps; and

FIG. 6 shows a side view of the clamp.

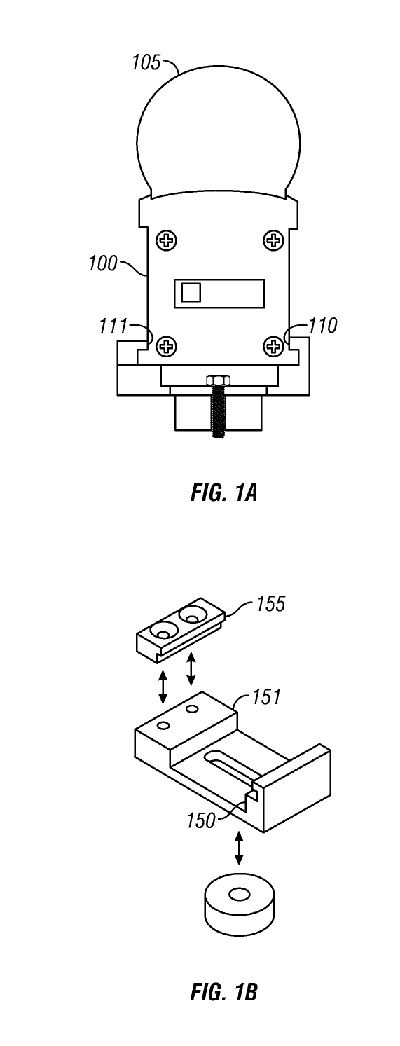

### SUMMARY

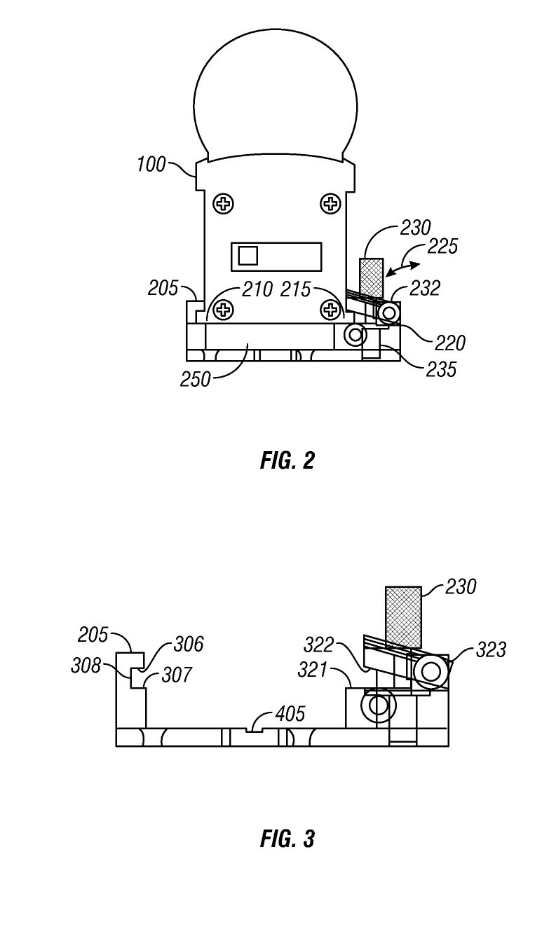

The present application describes a new form of clamp for a versa tube or similarly mechanically configured type of lighting device. FIG. 2 shows an end view of the versa tube and the clamping device of an embodiment. The versa tube may be an elongated device, for example, 1 foot long or longer. The clamping device clamps only a portion of the versa tube, for example, two or more 3 inch areas at different separated locations along the elongated tube.

The clamp includes a fixed clamping portion 205 which has an inside surface that presses against the outer edge surface 210, e.g., a mounting notch, on the outside of the tube housing. The notice has first and second holding surfaces 306, 307, which are substantially parallel to one another, and each extend horizontally. An opposite facing surface 308 extends between the first and second surfaces 306, 307. This notch 205 forms an un-movable pocket which is sized to fit a corresponding notch on a held element, here the versa tube. In FIG. 3, the other side which has the thumbscrew 230 includes first and second holding surfaces 321, 322. The first holding surface 321 is unmovable, and at substantially the same a height preferably as the bottom surface 307. The second holding surface 322 is hinged by a hinge 323 relative to the first holding surface. The second holding surface 322 can be pressed downward to hold the tube in place by the other edge surface 215. This forms a hinged clamping portion 220 which is capable of rotating and moving in the direction of the arrow 225. A spring 232, which can be a spiral spring, for example, can bias the hinge into the open position. When in the downward most position, a thumbscrew 230 connects to a screw portion 235 that can be screwed into the clamp body 250. The thumbscrew can be any kind of screw that can be tightened and loosened without tools, e.g., a screw with a roughened or knurled outer surface, or a wing nut, or other kind of tool-less screw. Alternatively, this can use a quick release pin, or a quarter turn screw. A tooled screw can also be used, or the screw can, for example, have a tool assist capability.

When screwed down, the versa tube is effectively held at its two edges via the two tabs 210, 215. However, the versa tube device 100 and can be easily removed without tools by simply loosening thumb screw 230. In addition, the device can be removed by loosening only this one single screw.

FIG. 3 illustrates a more detailed view of only the clamp showing the portions noted above.

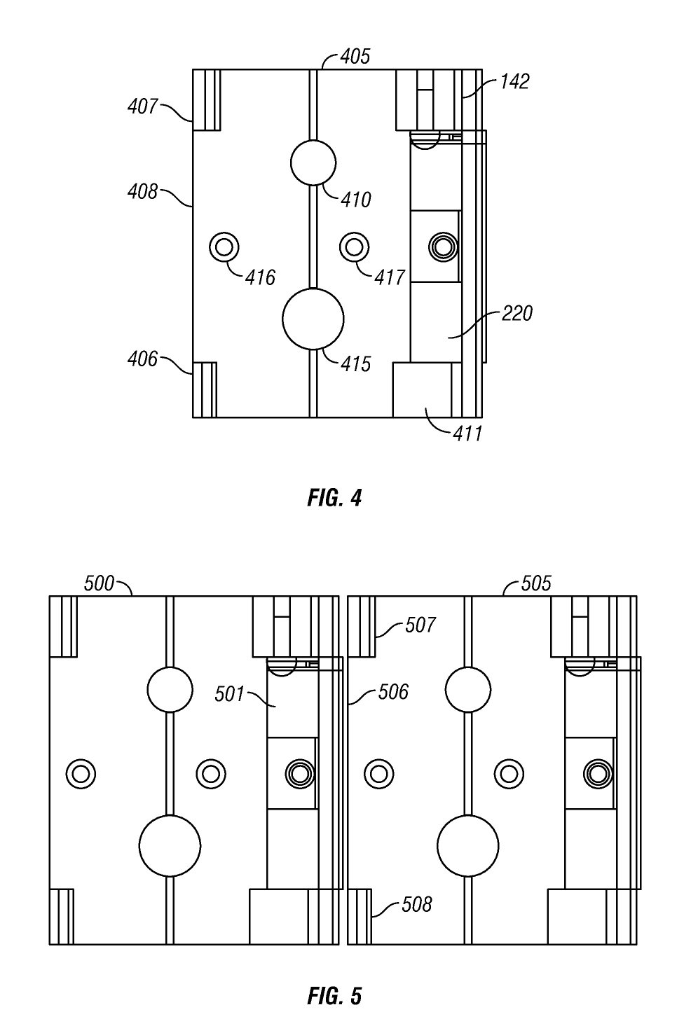

FIG. 4 shows a top view of the clamp. The clamp includes a machined line 405 which can also be seen in the view of FIG. 3. The line goes down the center of the clamp, and can hence be used for aligning relative to a line on the mounting surface. The clamp also includes a number of holes for screws, including the hole 410, a larger hole 415, as well as holes 416 and 417 which are sized for drywall screws, and which may be beveled on their edges, as shown. Other techniques can also be used; for example, the gaps 406,407 411, 412 can be held with a ziptie clamp or pipe clamp to hold the clamp to an object.

The fixed flange holding portion 205 is actually formed of two separated holding portions 406, 407 that collectively form a holding portion 405. A space 408 between the two portions has no such clamp holding portion. The hinged holding portion on the other side 220 is only located in the area longitudinally similar to area 408. There are open areas 411, 412 at areas corresponding to the area of the fixed portions of the clamp. That is, the portions on the two sides of the clamp are longitudinally non-adjacent to one another.

Because the hinged and fixed portions occupy totally separate longitudinally-adjacent areas, two of the clamp holders can be placed right next to each other while still allowing the devices to be installed and removed. FIG. 5 illustrates two versa tube clamps 500, 505 one right next to the other. The hinge 501 of clamp 500 is shown as opened completely in FIG. 5, since the open portion 501 goes into the space 506 between the two fixed flanges 507, 508 of the hinge of the unit 505.

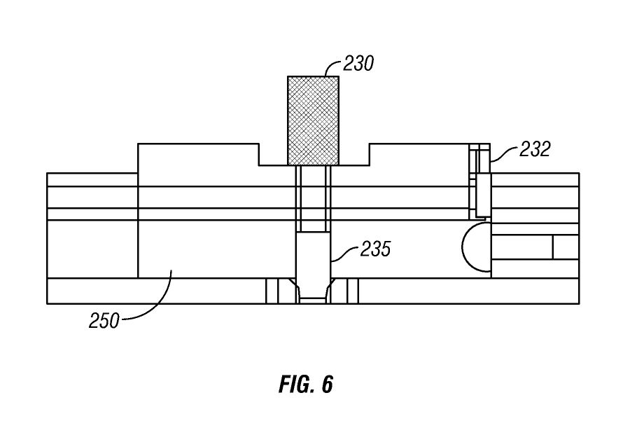

FIG. 6 illustrates a side view of the clamp, showing the thumbscrew 230 and how it can be screwed into a threaded receptable 235, causing it to press against the top surface of the closing mechanism 200, causing it to close against the force of the torsion spring 232 toward the base 250.

The clamp, as shown, may have an outer dimension of approximately 2½ inches wide (in the direction between the fixed portions of the clamps), and 3 inches long. Any other length may alternatively be used. The other figures show detailed assembly drawings illustrating assembly of the clamp.

Applicant intends that other modifications are included within this device, and intend that other sizes and types of lamps can be used to hold this device.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above uses the embodiment of a ‘versaclamp’, other elongated lamps can be mounted and monitored in an analogous way.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

1. A clamp for an elongated tube style lamp, comprising:
a housing,
said housing having a first holding portion, forming a notch which has at least three surfaces including first and second holding surfaces, that form a fixed pocket which is sized to fit a corresponding first notch on a held lamp element; and
said housing also having a second holding portion, located spaced a distance from said first portion, said second portion including a fixed bottom portion, and a hinged top portion which hinges on a hinge point that is spaced from and distant from said second holding portion, said top portion hinging on said point between a closed position where said top portion includes a pressing surface holds against a second notch of the held lamp element and hinges to an open position where said pressing surface no longer faces said bottom portion and does not hold said second notch of the held lamp element;
said housing having a bottom housing portion, extending between said first portion and said second portion; and
said housing including a fastener that is tightened to hold said pressing surface against said second notch, and where said second notch cannot be released from said pressing surface without loosening said fastener.

2. A clamp as in claim 1, further comprising a spring, pressing said hinged portion toward open position.

3. A clamp as in claim 2, wherein said fastener comprises a screw with a knurled exterior, capable of being tightened to press the second holding surface into a downward position against a force of said spring.

4. A clamp as in claim 1, wherein said fastener comprises a screw with a knurled exterior, capable of being tightened to press the pressing surface into a downward position against a force of said spring.

5. A clamp as in claim 1, further comprising.

6. A clamp as in claim 5, wherein said first portion and said second portion are adjacent to different parts on the housing portion.

7. A clamp as in claim 5, further comprising an alignment line, formed on said bottom housing portion, at a location that enables aligning an object therewith.

8. A clamp, comprising:
a housing portion;
a first side clamping portion, coupled to one side of said housing portion, and positioned for clamping a first side of a lamp, at only separated locations on the lamp and at plural ones of said separated locations;
a second side clamping portion, coupled to the other side of said housing portion, and clamping a second side of the lamp, at least at one location on the lamp,
wherein said plural separated locations are separated locations that are spaced longitudinally adjacent from one another.

9. A clamp as in claim 8, wherein said second side clamping portion comprises a portion which pivots relative to an axis between a first location which holds against nubs on the lamp, and a second position which allows the lamp to be removed.

10. A clamp as in claim 9, wherein said second side clamping portion is held by a single screw which has a knurled outer surface.

11. A clamp as in claim 8, wherein said first clamping portion is fixed and said second clamping portion is openable and closeable.

12. A clamp as in claim 8, further comprising a bottom housing portion, extending between said first and second side clamping portions.

13. A clamp as in claim 12, wherein said bottom housing portion includes an alignment line thereon.

14. A clamp as in claim 12, wherein said bottom housing portion includes at least one screw hole therein.

15. A tube style lamp assembly, comprising:
a tube lamp, extending along an axis, having an upper part with a light emitting along said axis, and having a bottom part supporting said upper part, said bottom part including first and second extending portions which extend away from said axis;
a housing having a first holding portion, forming a notch which has at least three surfaces including first and second holding surfaces, that form a fixed pocket which is sized to fit said first extending portion on said tube lamp; and
said housing also having a second holding portion, located spaced a distance from said first portion, said second portion including a fixed bottom portion, and a hinged top portion which hinges on a hinge point that is spaced from and distant from said second holding portion, said top portion hinging on said point between a closed position where said top portion includes a pressing surface holds against said second extending portion of the lamp and hinges to an open position where said pressing surface no longer faces said bottom portion and does not hold said second extending portion of the held lamp element;
said housing having a bottom housing portion, extending between said first portion and said second portion and
said housing including a fastener that is tightened to hold said pressing surface against said second extending portion, and where said second extending portion cannot be released from said pressing surface without loosening said fastener.

16. A clamp as in claim 1, further comprising a spring, pressing said hinged portion toward said open position.

17. A clamp as in claim 2, wherein said fastener comprises a screw with a knurled exterior, capable of being tightened to press the second holding surface into a downward position against a force of said spring.
